(19) United States
(12) Patent Application Publication
(10) Pub. No.: US 2024/0067169 A1
(43) Pub. Date: Feb. 29, 2024

(54) VEHICLE GUIDANCE SYSTEM

(71) Applicant: TOYOTA JIDOSHA KABUSHIKI KAISHA, Toyota-shi (JP)

(72) Inventors: Takayuki KAWAGUCHI, Toyota-shi (JP); Atsushi AYABE, Toyota-shi (JP)

(73) Assignee: TOYOTA JIDOSHA KABUSHIKI KAISHA, Toyota-shi (JP)

(21) Appl. No.: 18/458,269

(22) Filed: Aug. 30, 2023

(30) Foreign Application Priority Data
Aug. 31, 2022 (JP) 2022-138523

(51) Int. Cl. B60W 30/09; G08G 1/00

(52) U.S. Cl. CPC B60W 30/09; G08G 1/22; B60W 10/04; B60W 2556/65

(57) ABSTRACT

A vehicle guidance system of the present disclosure includes a guide device that guides the vehicle in a direction away from an estimated driving line estimated to be driven by other vehicle different from the vehicle as the evacuation direction based on the first information about a driving course on which the vehicle drive, the second information about the estimated driving line, and the third information about a current position of the vehicle.

### CROSS-REFERENCE TO RELATED APPLICATIONS

The present disclosure claims priority to Japanese Patent Application No. 2022-138523 filed Aug. 31, 2022, which is incorporated herein by reference.

### TECHNICAL FIELD

The present disclosure relates to a vehicle guidance system.

### BACKGROUND

A conventionally known vehicle guidance system guides a vehicle to an evacuation destination when a driver is unable to drive normally (as described in, for example, Japanese Patent Application Laid Open No. 2017-37454). The vehicle guidance system pre-sets an area that the vehicle can enter as the evacuation destination and guides the vehicle to the set evacuation destination.

### SUMMARY

When a vehicle drives toward the evacuation destination guided by the vehicle guidance system described above, a driving line of the vehicle may overlap with a driving line of the other vehicle. When the driving line of the vehicle overlaps the driving line of the other vehicle, the vehicle interferes with the driving of the other vehicle. A main object of the present disclosure is to suppress overlap between the driving lines of the vehicle and the other vehicle when the vehicle evacuates.

The vehicle guidance system of the the present disclosure has adopted the following measures to achieve the main objectives described above.

A vehicle guidance system of the present disclosure guides a vehicle in an evacuation direction. The vehicle guidance system includes a guide device guiding the vehicle in a direction away from an estimated driving line estimated to be driven by the other vehicle different from the vehicle as the evacuation direction based on the first information about a driving course on which the vehicle drive, the second information about the estimated driving line, and the third information about a current position of the vehicle.

In the vehicle guidance system of the present disclosure, the guide device guiding the vehicle in the direction away from the estimated driving line to be estimated to be driven by the other vehicle different from the vehicle as the evacuation direction based on the first information about the driving course on which the vehicle drive, the second information about the estimated driving line, and the third information about a current position of the vehicle. The vehicle guidance system enables to encourage a user of the vehicle to evacuate the vehicle in the evacuation direction. The user to be prompted to move the vehicle in the evacuation direction is able to move the vehicle in the guided evacuation direction, i.e., away from the estimated driving line. This enables the vehicle guidance system to suppress the overlap between the driving line of the vehicle and the other vehicle when the vehicle evacuates. Here, the “vehicle guidance system” may be an in-vehicle controller or the like installed in a vehicle, or it may be a combination of an in-vehicle controller or the like and a server communicating with the in-vehicle controller.

### BRIEF DESCRIPTION OF DRAWINGS

FIG. 1 is a schematic diagram of a vehicle guidance system 10 of the present disclosure;

FIG. 2 is a flowchart showing an example of a setup routine performed by a server 100;

FIG. 3 illustrates an example of an evacuation area Aev;

FIG. 4 is a flowchart illustrating an example of an evacuation direction guidance routine executed by an electronic control unit 50 of a vehicle 20; and

FIG. 5 is an illustration of an example of the relationship between the vehicle 20 driving on a circuit and the evacuation direction displayed on a display 70.

### DESCRIPTION OF EMBODIMENTS

The following describes some aspects of the present disclosure with reference to drawings.

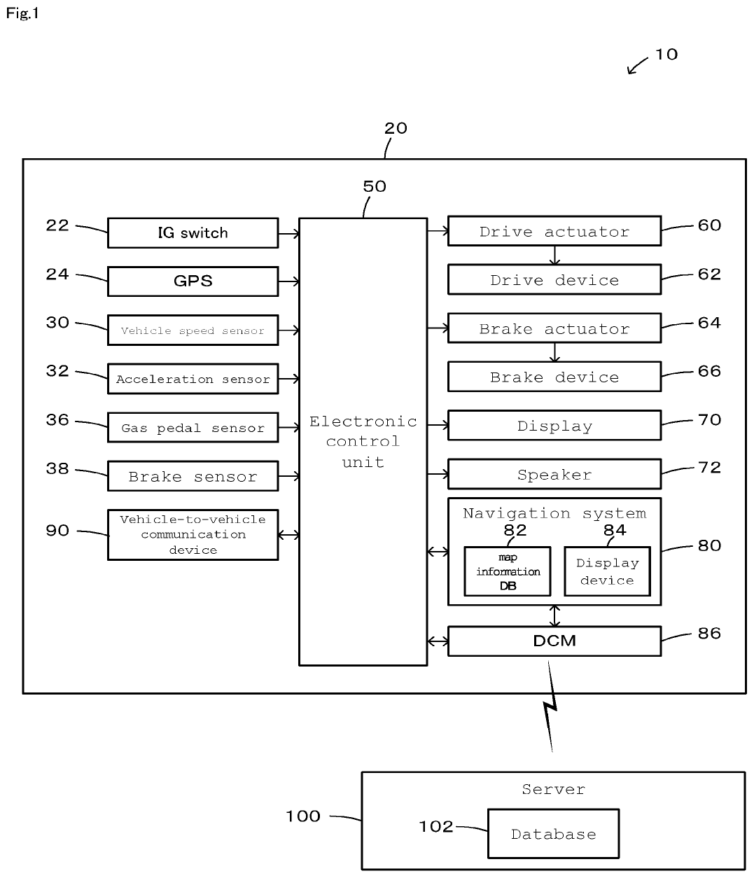

FIG. 1 is a schematic diagram of a vehicle guidance system 10 of the present disclosure. The vehicle guidance system 10 is a system for guiding a vehicle 20 on a circuit in a direction to evacuate and includes the vehicle (own vehicle) 20 and a server 100.

The vehicle 20 is configured as an automobile that drives on power from a drive device 62 such as a motor or an engine. In addition to the drive device 62, the vehicle 20 includes an ignition switch 22, a Global Positioning System (GPS) 24, a vehicle speed sensor 30, an acceleration sensor 32, a gas pedal sensor 36, a brake sensor 38, an electronic control unit 50, a drive actuator 60, a brake actuator 64, a brake device 66, a display 70, a speaker 72, a navigation system 80, a DCM (Data Communication Module) 86, and a vehicle-to-vehicle communication device (a communication device) 90.

The GPS 24 is a device that detects a position of the vehicle 20 based on signals transmitted from multiple GPS satellites. The vehicle speed sensor 30 detects speed of the vehicle 20 based on wheel speed and other factors. The acceleration sensor 32 detects, for example, acceleration of the vehicle 20 in front-back direction or acceleration of the vehicle 20 in left-right (lateral) direction.

The gas pedal sensor 36 detects the gas pedal opening degree, etc., according to amount of depressing the gas pedal by the driver. The brake sensor 38 detects brake position, etc., as amount of depressing the brake pedal by the driver.

The drive device 62 includes a motor and an engine for driving and is driven and controlled by the drive actuator 60.

The DCM 86 transmits information about the vehicle to the server 100 and receives information about the circuit and other driving courses from the server 100. The information about the vehicle includes, for example, a vehicle's position, speed, driving power, driving mode, etc. The information about the driving course includes information about location of the evacuation area Aev described later. The DCM 86 communicates with the server 100 at predetermined intervals (e.g., every 30 seconds, 1 minute, 2 minutes, etc.).

The electronic control unit 50, not shown in the figure, is configured as a microcomputer with a CPU at its core. The electronic control unit 50 includes ROM, RAM, flash memory, input ports, output ports, and communication ports in addition to the CPU. The electronic control unit 50 sets required torque to be output from the drive device 62 to the drive shaft to which the drive wheels are connected and required braking torque to be output from the brake device 66 based on gas pedal position from the gas pedal sensor 36, brake position from the brake sensor 38, and vehicle speed from the vehicle speed sensor 30. The electronic control unit 50 transmits to the drive actuator 60 for the set required torque and to the brake actuator 64 for the set required braking torque. The electronic control unit 50 transmits position information of the vehicle 20 from the GPS 24 to the server 100 via the DCM 86 every time T1 (e.g., every few seconds).

The drive actuator 60 drives and controls the drive device 62 such that the required torque set by the electronic control unit 50 is output from the drive device 62 to the drive shaft.

The brake actuator 64 controls the brake device 66 such that the required braking torque set by the electronic control unit 50 is applied to the vehicle 20 by the brake device 66.

The display 70 is configured as a display device to display various types of information visibly. The display 70 is integrated into dashboard of the vehicle 20. The display 70 is controlled by the electronic control unit 50.

The speaker 72 is configured as an audio output device to output various information output from electronic control unit 50 as sound. The speaker 72 is integrated into the dashboard of the vehicle 20. The speaker 72 is controlled by the electronic control unit 50.

The navigation system 80 is a system to guide the vehicle to a set destination. The navigation system 80 includes a map information database 82 and a display device 84. Map information is stored in the map information database 82. When the destination is set, the navigation system 80 sets a route and provides route guidance based on information of the destination, current location (current position of the vehicle) obtained by the GPS 24, and the information stored in the map information database 82.

The vehicle-to-vehicle communication device 90 receives information (position, speed, etc.) from a surrounding vehicle (the other vehicle) via wireless communication. The vehicle-to-vehicle communication device 90 transmits the information (the position, the speed, etc.) of the vehicle (own vehicle) 20 to the surrounding vehicles.

The server 100 is configured as a well-known computer. The server 100 includes a CPU, ROM, RAM, an auxiliary memory (e.g., flash memory), a main memory (e.g., HDD or SSD), and a communication device. The server 100 is configured to communicate wirelessly with multiple vehicles. The main memory stores database 102. The database 102 stores information about circuits located in various regions (first information, such as shape, condition, width, and location on a map (longitude and latitude) of the courses). The database 102 stores information on a position (longitude and latitude) Po of vehicles that was driven in the past at the circuits located in the various regions. The database 102 stores information about an estimated driving line Lest. The estimated driving line Lest is a driving line to be estimated to be driven by the other vehicle different from the vehicle at each circuit. The database 102 stores information about an evacuation area Aev in each circuit. The vehicle position Po is a current position (longitude and latitude) of each vehicle transmitted to the server 100 at every time T1 when each vehicle drives the circuit.

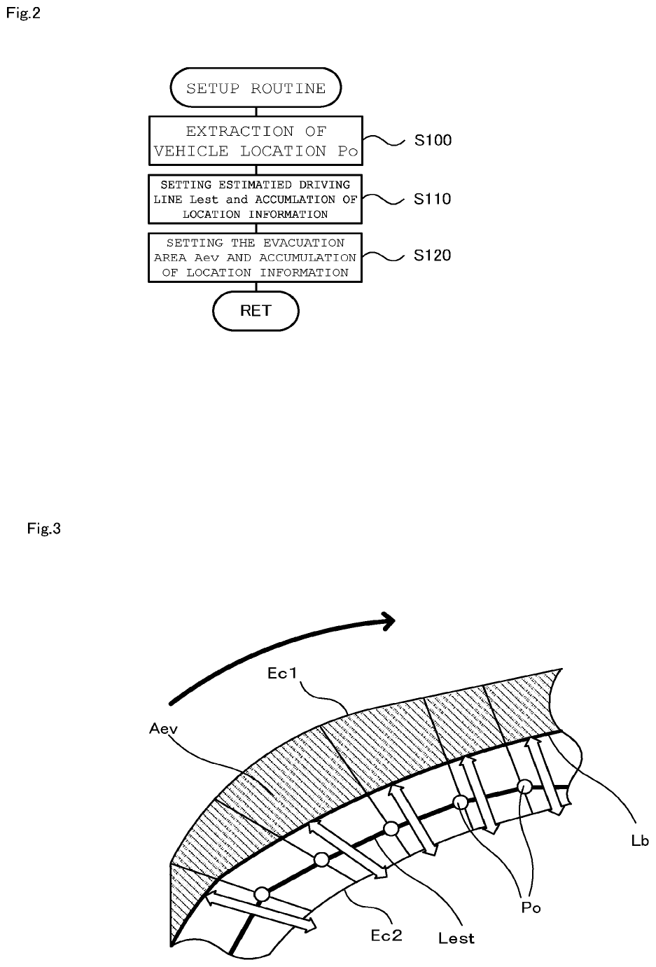

FIG. 2 is a flowchart showing an example of a setup routine performed by the server 100. The CPU of the server 100 executes the setup routine at every time T2 (e.g., every hour, every 12 hours, every day, etc.).

For each circuit, the server 100 extracts from the database 102 the vehicle position Po at the time each vehicle drove on that circuit in the past (step S100).

The server 100 sets a record line to an estimated driving line Lest. The record line is the fastest line around the circuit among the driving lines for each vehicle obtained by linear interpolation on the extracted vehicle position Po. The server 100 stores the location information (longitude, latitude, and second information) of the set estimated driving line Lest in the database 102 (step S110). Instead of the record line at the circuit, the CPU of the server 100 may set a high frequency driving line to be highest frequency driving line from each vehicle's driving line and set the high frequency driving line to the estimated driving line Lest.

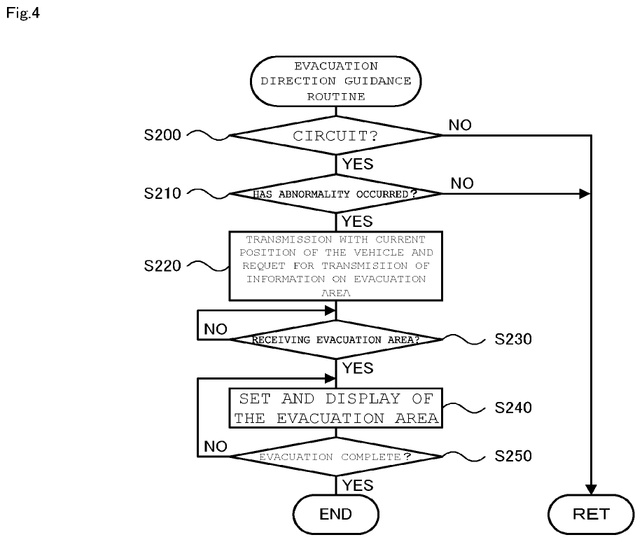

The server 100 sets an evacuation area Aev to which the vehicle 20 head when the vehicle 20 evacuates on the circuit, stores location information of the set evacuation area Aev in the database 102 (step S120), and terminates this routine. FIG. 3 illustrates an example of the evacuation area Aev. In the figure, white circles indicate the vehicle position Po at a given time. The server 100 sets the evacuation area Aev to an area enclosed by a boundary line Lb and a course edge Ec1 (an area hatched in the figure). The boundary line Lb is line to connect the points to be a predetermined distance Lref away from the estimated driving line Lest in left-right directions (direction indicated by white-painted arrow in the figure). In the figure, since distance from the estimated driving line Lest to the course edge Ec2 is less than predetermined distance Lref, the evacuation area Aev is not set on the course edge Ec2 side of the estimated driving line Lest. The evacuation area Aev thus set is an area equal to or higher than the predetermined distance Lref away from the estimated driving line Lest in the left-right directions. Thus, these processes, the server 100 accumulates the estimated driving line Lest and the evacuation area Aev for each circuit in the database 102.

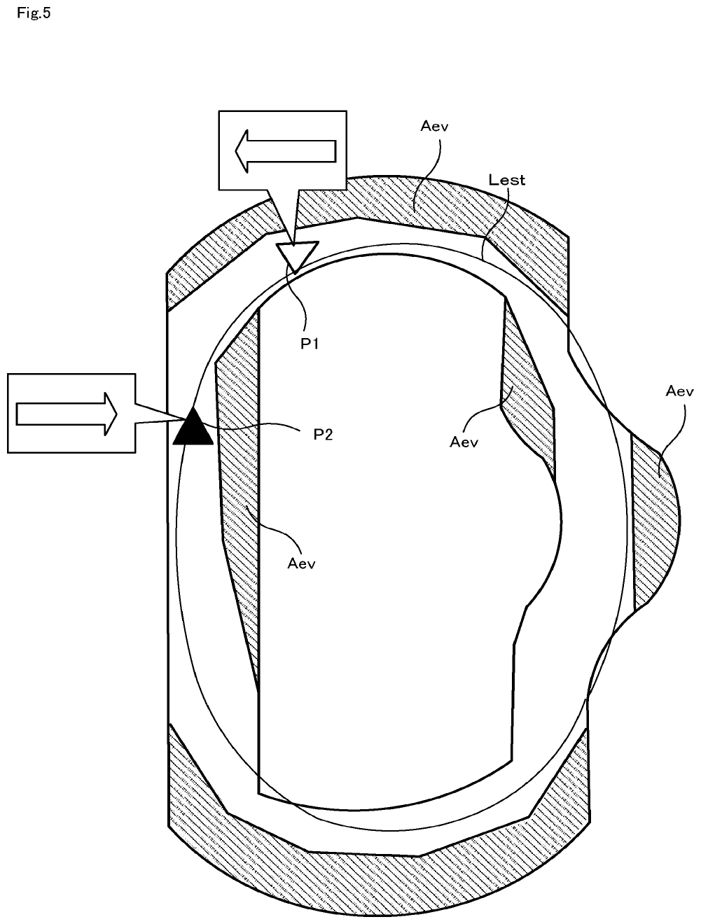

The process of the electronic control unit 50 and the display 70 of the vehicle 20 guiding the evacuation direction is described next. FIG. 4 is a flowchart illustrating an example of an evacuation direction guidance routine executed by the electronic control unit 50 of the vehicle 20. This routine is repeatedly executed by the CPU of the electronic control unit 50.

The electronic control unit 50 determines whether or not the vehicle 20 is driving in the circuit (step S200) and whether or not an abnormality has occurred in the vehicle 20 (step S210). In the step S200, the electronic control unit 50 determines whether or not the vehicle 20 is driving in the circuit based on information on the current position of the vehicle 20 from the GPS 24 (third information) and map information stored by the map information database 82 of the navigation system 80. In the step S210, the electronic control unit 50 determines that an abnormality has occurred in the vehicle 20 when a decrease in tire pressure is detected or when a warning light indicating that some abnormality is occurred in the vehicle is on. When vehicle 20 is not currently driving in the circuit, or when vehicle 20 is currently driving in the circuit but no abnormality has occurred in vehicle 20, the electronic control unit 50 terminates this routine.

When the vehicle 20 is currently driving in the circuit in step S200 and an abnormality has occurred in vehicle 20 in step S210, the electronic control unit 50 transmits the current position of the vehicle 20 and a request for transmission of information on the evacuation area Aev to the server 100 via the DCM 86 (step S220) and waits until the information of the evacuation area Aev is received via the DCM 86 (step S230). The server 100 that receives the current position of the vehicle 20 and the request for transmission of the evacuation area Aev, the server 100 identifies the circuit on which vehicle 20 is driving based on the current position of the vehicle 20, extracts the location information of the evacuation area Aev of the circuit on which vehicle 20 is currently driving from the evacuation area Aev of each circuit stored in the database 102 and transmits the location information of the evacuation area Aev of the circuit on which the vehicle 20 is currently driving to the vehicle 20.

When the electronic control unit 50 receives the position information of the evacuation area Aev, the electronic control unit 50 sets direction toward the nearest evacuation area Aev in the left-right direction of the vehicle 20, that is, the direction away from the estimated driving line Lest, to the evacuation direction based on the received position information of the evacuation area Aev and the current position of the vehicle 20 from GPS 24, and the electronic control unit 50 display the evacuation direction on the display 70 (step S240). FIG. 5 is an illustration of an example of the relationship between the vehicle 20 driving on the circuit and the evacuation direction displayed on the display 70. The white and black triangles in the figure respectively indicate the positions P1 and P2 of the vehicle 20. The shaded hatched area indicates the evacuation area Aev. At position P1, the evacuation area Aev of left side of the vehicle 20 among the multiple evacuation areas Aev is the closest to the vehicle 20 and an arrow pointing to the left is displayed on display 70. At position P2, the evacuation area Aev of right side of the vehicle 20 among the multiple evacuation areas Aev is the closest to the vehicle 20 and an arrow pointing to the right is displayed on display 70. The electronic control unit 50 thus guides the user of the vehicle 20 in the evacuation direction by displaying the arrow on the display 70, thereby encouraging the user of the vehicle 20 to drive the vehicle 20 away from the estimated driving line Lest and to evacuate. The user encouraged to drive the vehicle 20 in the evacuation direction can evacuates the vehicle 20 in the guided evacuation direction, i.e., away from the estimated driving line Lest. This enables reporting device of the embodiment reporting device to suppress the overlap of the driving line of the vehicle 20 and the driving line of the other vehicle.

Next, the electronic control unit 50 determines whether the evacuation is completed based on the current position of the vehicle 20 from the GPS 24, i.e., whether the vehicle 20 has moved within the evacuation area Aev (step S250). When the evacuation is not complete, the electronic control unit 50 repeats the steps S240 and S250. When the evacuation is complete, the electronic control unit 50 finishes displaying the evacuation direction on the display 70 and terminates this routine. Thus, the electronic control unit 50 displays the evacuation direction on the display 70 until the evacuation of the vehicle 20 is complete. This enables to more reliably evacuate the vehicle 20 to the evacuation area Aev.

In the vehicle guidance system 10 of the embodiment described above, the electronic control unit 50 and the display 70 guide the vehicle the direction away from the estimated driving line Lest as the evacuation direction based on the location information of the circuit, the estimated driving line Lest, and the current position of the vehicle 20. This enables the vehicle guidance system 10 to suppress the overlap between the driving line of the vehicle 20 and the other vehicle.

In the vehicle guidance system 10 of the embodiment, the electronic control unit 50 and the display 70 guide the vehicle 20 in a direction away from the estimated driving Lest and toward the evacuation area Aev as the evacuation direction based on the location information of the circuit, the estimated driving line Lest, and the current position of the vehicle 20 when an abnormality occurs in the vehicle 20. This enables the vehicle guidance system 10 to guide the user in the evacuation direction when the abnormality occurs in the vehicle 20.

In the vehicle guidance system 10 of the embodiment, the estimated driving line Lest is the record line or the high frequency driving line. This enables the vehicle guidance system 10 to guide the user in a more appropriate evacuation direction and to more appropriately suppress the overlap between the driving line of the vehicle and the other vehicle.

In the vehicle guidance system 10 of the embodiment, the electronic control unit 50 and the display 70 guide the vehicle 20 in the direction toward the evacuation area Aev as the evacuation direction. The evacuation area Aev is at least the predetermined distance Lef from the estimated driving line Lest in the left-right directions on the circuit and is the closest to the current position of the vehicle 20. This enables the vehicle guidance system 10 to more appropriately suppress the overlap between the driving line of the vehicle 20 and the other vehicle.

In the vehicle guidance system 10 of the embodiment, the electronic control unit 50 sets the record line at the circuit to the estimated driving line Lest. However, the estimated driving line Lest may be a previous driving line of the other vehicle following the vehicle 20. The previous driving line is the line that the other vehicle drove around the course immediately before. When the driving course is a circuit, the following vehicles are likely to drive on the previous driving line or a line similar to the previous driving line. Therefore, by setting the estimated driving line Lest to the immediately preceding driving line, the electronic control unit 50 and the display 70 can display the evacuation direction on the display 70 based on the more appropriate estimated driving line Lest. The vehicle guidance system 10 is able to guide the user to a more appropriate evacuation direction. This enables the vehicle guidance system 10 to suppress the overlap between the driving line of the vehicle 20 and the other vehicle.

In the vehicle guidance system 10 of the embodiment, the estimated driving line Lest is the record line. However, the vehicle 20 may receive the record line of the circuit from the following vehicle via a vehicle-to-vehicle communication device 90 when the following vehicle of the vehicle 20 includes the vehicle-to-vehicle communication device similar to the vehicle-to-vehicle communication device 90, and the electronic control unit 50 may set the estimated driving line Lest to record line. In this case, the electronic control unit 50 set the evacuation area Aev in a process similar to the step S120 and display the evacuation direction on the display 70 using the set evacuation area Aev. Vehicles following the vehicle 20 are likely to drive on the circuit's record line or a driving line similar to the record line. Therefore, by using the record line received via vehicle-to-vehicle communication as the estimated driving line Lest, the electronic control unit 50 and display 70 display the evacuation direction based on the more appropriate estimated driving line Lest. The vehicle guidance system 10 guides the user to a more appropriate evacuation direction. This enables the vehicle guidance system 10 to suppress the overlap between the driving line of the vehicle 20 and the other vehicle.

In the vehicle guidance system 10 of the embodiment, the electronic control unit 50 and the display 70 guide the vehicle 20 in the direction away from the estimated driving line Lest and toward the evacuation area Aev when an abnormality occurs in the vehicle 20. However, the electronic control unit 50 and the display 70 guide the vehicle 20 in the direction away from the estimated driving line Lest and toward the evacuation area Aev when no abnormality occurs in the vehicle 20.

In the vehicle guidance system 10 of the embodiment, the electronic control unit 50 and the display 70 guide the vehicle 20 in the direction away from the estimated driving line Lest and toward the evacuation area Aev. However, the electronic control unit 50 and the display 70 may guide the vehicle 20 in the direction away from the estimated driving line Lest, without considering the evacuation area Aev.

In the vehicle guidance system 10 of the embodiment, the electronic control unit 50 displays the evacuation direction on the display 70 in the step S240. However, instead of displaying the evacuation direction on the display 70, or in addition to displaying the evacuation direction on the display 70, the electronic control unit 50 may display the evacuation direction on the display device 84 of the navigation system 80, or the evacuation direction may be output audibly from the speaker 72.

In the vehicle guidance system 10 of the embodiment, the electronic control unit 50 displays the evacuation direction on the display 70 in the step S240. However, in the step S240, the electronic control unit 50 may display the evacuation area Aev along with the evacuation direction on the display 70 along with map information.

In the vehicle guidance system 10 of the embodiment, the driving course is the circuit. However, the driving course is not limited to a circuit-like course to be lapped, but may be any course on which the vehicle 20 is able to drive.

In the vehicle guidance system 10 of the embodiment, the server 100 sets the estimated driving line Lest, the evacuation area Aev, and the electronic control unit 50 sets the evacuation direction. However, the server 100 may set the estimated driving line Lest, the evacuation area Aev, and the evacuation direction. In this case, the server 100 may transmit the set evacuation direction to the electronic control unit 50, and the electronic control unit 50 may display the received evacuation direction on the display 70. The server 100 may set the estimated driving line Lest and transmit it to the electronic control unit 50, and the electronic control unit 50 may set the evacuation area Aev and evacuation direction using the received estimated driving line Lest.

In the vehicle guidance system of the present disclosure, the guide device may guide the vehicle in a direction away from the estimated driving line as the evacuation direction based on the first, the second, and the third information when an abnormality occurs in the vehicle. This enables the vehicle guidance system to guide the user in the evacuation direction when an abnormality occurs in the vehicle.

In the vehicle guidance system of the present disclosure, the driving course may be a circuit and the estimated driving line may be a record line in the circuit or high frequency driving line to be driven with high frequency. Other vehicles are likely to drive on the record line or a driving line similar to the record line on the circuit, or on the high frequency driving line to be driven with high frequency or a driving line similar to the high frequency driving line. Therefore, setting the estimated driving line to a record line or the high frequency driving line enables the guidance device to guide the user in a more appropriate evacuation direction. This enables the vehicle guidance system to more appropriately suppress the overlap between the driving line of the vehicle and the other vehicle.

In the vehicle guidance system of the present disclosure, the driving course may be a circuit, the other vehicle may be a vehicle following the vehicle and the estimated driving line may be a previous driving line to be the line that the other vehicle drove around the course immediately before. When the driving course is a circuit and the other vehicle is a following vehicle of the vehicle, the other vehicle is likely to drive on the driving line of the last time it went around the driving course. Therefore, setting the other vehicle to the following vehicle of the vehicle and the estimated driving line to the previous driving line enables the guidance device to guide in the evacuation direction based on a more appropriate estimated driving line. The vehicle guidance system is able to guide the user to a more appropriate evacuation direction. This enables the vehicle guidance system to more appropriately suppress the overlap between the driving line of the vehicle and the other vehicle.

In the vehicle guidance system of the present disclosure, the guide device may guide the vehicle in the direction toward an evacuation area as the evacuation direction. The evacuation area is at least a predetermined distance from the estimated driving line in the left-right directions on the driving course and is the closest to the current position of the vehicle. Thus, the guidance device quickly guides the user in the direction of possible evacuation. This enables the vehicle guidance system to more appropriately suppress the overlap between the driving line of the vehicle and the other vehicle.

In the vehicle guidance system of the present disclosure, the guide device may guide the evacuation direction and the location information of the evacuation area. The vehicle guidance system guides the user on how far to specifically evacuate to avoid overlapping with the line of driving of another vehicle. This enables the vehicle guidance system to more appropriately suppress the overlap between the driving line of the vehicle and the other vehicle.

In the vehicle guidance system of the present disclosure, the vehicle guidance system may include a communication device receiving a record line in the circuit or a previous driving line of the other vehicle's last lap around the driving course from the other vehicle via vehicle-to-vehicle communication. The other vehicle may be a vehicle following the vehicle. The driving course may be a circuit and the estimated driving line may be the record line or the previous driving line received via the vehicle-to-vehicle communication. When the driving course is a circuit and the other vehicle is a following vehicle of the vehicle, the other vehicle is likely to drive on the driving line of the last time it went around the driving course. Therefore, setting the record line or the previous driving line received via vehicle-to-vehicle communication to the estimated driving line enables the guidance system to guide the user in the evacuation direction based on a more appropriate estimated driving line. The vehicle guidance system is able to guide the user to a more appropriate evacuation direction. This enables the vehicle guidance system to more appropriately suppress the overlap between the driving line of the vehicle and the other vehicle.

The following is an explanation of the correspondence between the main elements of the embodiment and the main elements of the invention described in the section on means to solve the problem. In the embodiment, the electronic control unit 50 and the display 70 corresponds to a “guide device”.

The correspondence between the major elements of the embodiment and the major elements of the invention described in the means to solve a problem section is an example of how the embodiment can be used to specifically explain the embodiment of the invention described in the means to solve a problem section. This does not limit the elements of the invention described in the means to solve the problem section. In other words, interpretation of the invention described in the means to solve a problem section should be based on the description in that section, and the embodiment is only one specific example of the invention described in the means to solve a problem section.

The above is a description of the form for implementing this disclosure using the embodiment. However, the present disclosure is not limited in any way to these embodiments, and can of course be implemented in various forms within the scope that does not depart from the gist of the present disclosure.

### INDUSTRIAL APPLICABILITY

This disclosure is applicable to the vehicle guidance system manufacturing industry and other applications.

1. A vehicle guidance system configured to guide a vehicle in an evacuation direction, the vehicle guidance system comprising:
a guide device configured to guide the vehicle in a direction away from an estimated driving line estimated to be driven by other vehicle different from the vehicle as the evacuation direction based on the first information about a driving course on which the vehicle drive, the second information about the estimated driving line, and the third information about a current position of the vehicle.

2. The vehicle guidance system according to claim 1,
wherein the guide device guides the vehicle in a direction away from the estimated driving line as the evacuation direction based on the first, the second, and the third information when an abnormality occurs in the vehicle.

3. The vehicle guidance system according to claim 1,
wherein the driving course is a circuit and
wherein the estimated driving line is a record line in the circuit or high frequency driving line to be driven with high frequency.

4. The vehicle guidance system according to claim 1,
wherein the driving course is a circuit,
wherein the other vehicle is a vehicle following the vehicle and
wherein the estimated driving line is a previous driving line that the other vehicle drove around the course immediately before.

5. The vehicle guidance system according to claim 1,
wherein the guide device guides the vehicle in the direction toward an evacuation area as the evacuation direction and
wherein the evacuation area is at least a predetermined distance from the estimated driving line in the left-right directions on the driving course and is the closest to the current position of the vehicle.

6. The vehicle guidance system according to claim 5,
wherein the guide device guides the vehicle in the evacuation direction and location information of the evacuation area.

7. The vehicle guidance system according to claim 1,
further comprising a communication device configured to receive a record line in the circuit or the last previous driving line of the other vehicle's last lap around the driving course from the other vehicle via vehicle-to-vehicle communication,
wherein the other vehicle is a vehicle following the vehicle,
wherein the driving course is a circuit and
wherein the estimated driving line is the record line or the previous driving line received via the vehicle-to-vehicle communication.
